(19) United States
(12) Patent Application Publication
(10) Pub. No.: US 2006/0019633 A1
(43) Pub. Date: Jan. 26, 2006

(54) Mobile telephone alarm system cellular alarm for cars

(76) Inventor: David Mark Capone, San Juan, PR (US)

Correspondence Address: David Mark Capone, P.O. Box 9065172, San Juan, PR, 00906-5172, US

(21) Appl. No.: 10/822,450

(22) Filed: Jul. 22, 2004

(51) Int. Cl. H04M 1/00; H04B 1/38; H04M 1/66

(52) U.S. Cl. 455/410; 455/556.1

(57) ABSTRACT

My invention is the connection and use of car owner's mobile telephone unit connected to the car alarm systems as a security measure and to avoid noise pollution, which is known as A mobile telephone Alarm system, cellular alarm for cars. This invention is a car alarm system incorporated and established into the cellular phone of the cars' owner that will show in the cellular screen diverse pictures/images and it will phone the cellular unit with different sounds alerting the car owner of the automobile condition.

The purpose of my invention is a car alarm system connected the cellular phone which will make the cellular phone to ring with different types of sounds and images that will flash on the screen of the cellular phone on and off when the car alarm system is activated. The improvement to the telephone unit is described as a cellular phone that will have a specific button incorporated in the cellular phone or a specific coded number on the cellular menu with any specific numeration provided by the mobile phone cellular industry. If the car has been started or if the motor was started from the ignition, it will show a picture related to the incidents, which are to be, send to the cellular phone screen.

My claim if the idea to have a connection of the mobile telephone alarm system with and into the automobiles' alarm system using sounds, cellular calls and pictures flashing on and off, on the cellular phones of the owner of the car are designed to avoid noise pollution. An optional feature will be that the car alarm can also sound from your car and or from your cellular phone or both the car and the cellular phone.

The Mobile Telephone Alarm System, cellular alarm for cars might be use by incorporating its functions to the existing cellular phone towers, microwaves, booms or/and satellite systems. This system might be possible (like) a low jack system with the cellular phone towers using booms and/or microwaves to locate the vehicle. This unit can be simple to add as a feature to the cellular phone and a simple alarm system to your car.

The use of Mobile Telephone Alarm System, Cellular Alarm for Cars will provide the phone companies with a new service product for which they can charge a fee for the phone service and alarm system to the car. Also, it could be incorporated to the home alarm system. The internal incorporation of the car alarm system into the mobile cellular phone will be by electronically design and/or any means necessary to establish the connection.

How the Mobile Telephone Alarm System, cellular alarm for cars, I claim it will work? Examples: If you are in a meeting, bar, restaurant, store, home or any place away from your car and the car alarm is activated, How will you know? Your phone will alert you. A picture of a car, a truck or all types of automobiles will be on the cellular screen along with sounds and a flashing screen to alert you as programmed into the cellular unit. If you are away from your car and the car alarm is going off, it will be program into the cellular phone as if you have a phone call or using pictures and diverse sounds.

1. What I claim as my invention is the idea of having a mobile cellular telephone alarm system connected to the car. I claim that the idea of the mobile cellular phone will alert the owner of the car via images, sounds and calls in the cellular unit and this product is known as the Mobile Telephone Alarm System, Cellular Alarm for cars. I claim that the car alarm system will have no apparent sound but the connection to the mobile telephone unit will alert the mobile telephone owner of the attempts to break into his car.
